(19) United States
(12) Patent Application Publication
(10) Pub. No.: US 2021/0339408 A1
(43) Pub. Date: Nov. 4, 2021

(54) Reciprocating Knife Assembly

(71) Applicant: Greg Dickinson, Brigham City, UT (US)

(72) Inventor: Greg Dickinson, Brigham City, UT (US)

(21) Appl. No.: 17/372,754

(22) Filed: Jul. 12, 2021

Related U.S. Application Data
(63) Continuation-in-part of application No. 16/686,709, filed on Nov. 18, 2019, now abandoned.
Application No. 16/686,709 is a continuation-in-part of application No. 29/738,669, filed on Jun. 18, 2020.

(51) Int. Cl. B26B 7/00; B26B 11/00; B26B 1/10; B26B 5/00

(52) U.S. Cl. CPC B26B 7/005; B26B 11/008; B26B 9/02; B26B 5/003; B26B 1/10

(57) ABSTRACT

The present invention is a reciprocating culinary knife assembly. The assembly is battery operated and operates a steak knife in reciprocating fashion. An ergonomic, oversized handle portion is designed for users with arthritis or other debilitating conditions that render handling small implements difficult. A single removable battery pack is contained within a battery chamber formed at one end of the housing for the assembly; the pack designed for easy snap fit within the chamber. The housing is made of a rigid material which is covered with a pliable material such as rubber or silicon to enhance gripping and further reduce discomfort. A pressure-sensing mechanism operates as an on/off switch to enhance user safety.

### CROSS-REFERENCE TO RELATED APPLICATION

This application claims priority as a Continuation-In-Part to U.S. patent application Ser. No. 16/686,709, titled “Reciprocating Knife Assembly,” and filed on May 6, 2020. This application also claims priority as a Continuation-In-Part to U.S. patent application Ser. No. 29/738,669, titled “CARVING KNIFE,” and filed on Jun. 18, 2020. Both of these applications are herein incorporated by reference in their entirety.

### FIELD OF THE INVENTION

The present invention relates generally to cutting tools. More particularly, the invention relates to a reciprocating culinary knife.

### BACKGROUND OF THE INVENTION

Electric carving knives have been around for many years. Most are large chef or culinary knives that are connected to a source of AC power. While generally satisfactory for their intended purpose, these implements suffer from some drawbacks. First, the handles tend to have a very small circumference, even if they are considered “ergonomic.” While this may be satisfactory for many users, people with arthritis or other conditions find it difficult to control such knives. Also, the handle portion tends to be made from rigid materials which can also be uncomfortable for people with musculoskeletal issues. Finally, the battery-powered knives tend to have several batteries which are packed end to end in an elongated battery chamber making battery replacement tedious.

### SUMMARY OF THE INVENTION

The present invention is a reciprocating culinary knife assembly. The assembly is battery-operated and operates a steak knife in reciprocating fashion. An ergonomic, oversized handle portion is designed for users with arthritis or other debilitating conditions that render handling small implements difficult. A single removable battery pack is contained within a battery chamber formed at one end of the housing for the assembly; the pack designed for easy snap fit within the chamber.

The housing is made of a rigid material which is covered with a pliable material such as rubber or silicon to enhance gripping and further reduce discomfort. A pressure-sensing mechanism operates as an on/off switch to enhance user safety.

It is a major object of the invention to provide an improved reciprocating knife assembly.

It is another object of the invention to provide an improved battery-powered knife assembly.

It is another object of the invention to provide an improved battery-powered knife assembly with an ergonomic handle.

It is another object of the invention to provide an improved battery-powered knife assembly with an oversized handle.

It is another object of the invention to provide an improved battery-powered knife assembly with a slide-out battery pack

It is another object of the invention to provide an improved battery powered knife assembly having a finger guard.

It is another object of the invention to provide an improved battery powered knife assembly having a pressure sensing means for controlling actuation.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

### BRIEF DESCRIPTION OF THE DRAWINGS

FIGS. 1a-b show side perspective views of a first embodiment of a reciprocating knife assembly of the present invention.

FIGS. 2a-f show various views of a first embodiment of a reciprocating knife assembly of the present invention.

FIGS. 3a-b show perspective views of a first embodiment of the mechanism within a reciprocating knife assembly according to the present invention.

FIG. 4 shows a perspective view of a second embodiment of the reciprocating knife assembly according to the present invention.

FIG. 5 shows a perspective view of a second embodiment of the reciprocating knife assembly according to the present invention.

FIG. 6 shows a perspective view of a second embodiment of the mechanism of the reciprocating knife assembly of the present invention.

### DETAILED DESCRIPTION

The present invention is directed to a reciprocating knife assembly, generally indicated by the numeral 10. The assembly 10 is intended primarily for use by persons with grasping issues, such as arthritis, and is preferably sized as a steak knife, but the concept of the invention may be extended to any culinary knife or reciprocating saw.

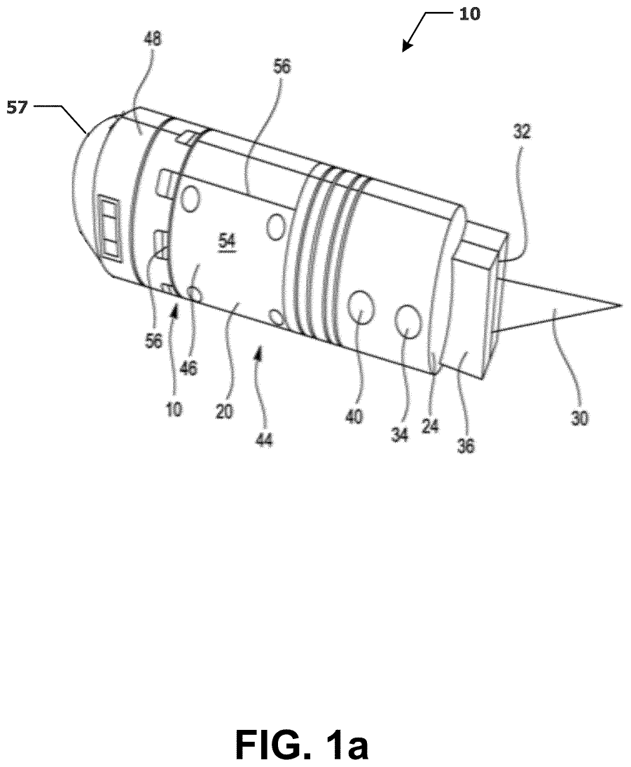

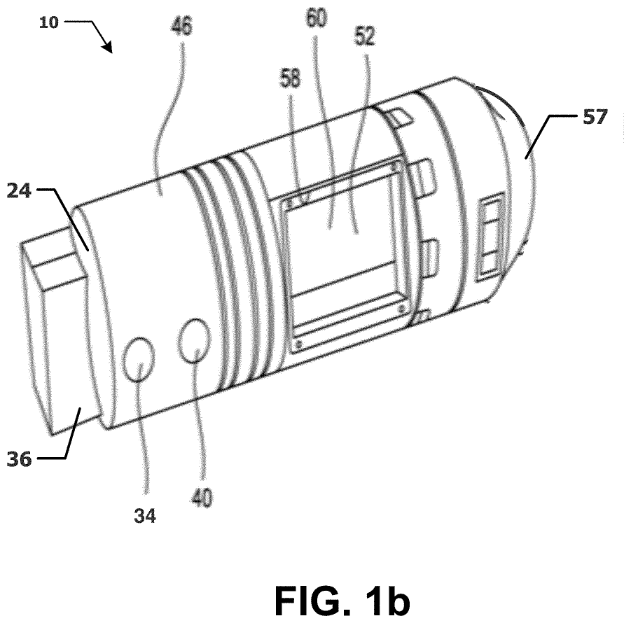

FIGS. 1a-b show each of the respective side perspective views of a first embodiment of a reciprocating knife assembly of the present invention. The housing 20 for the assembly 10 is “oversized” in that the handle portion is oversized relative to a standard steak knife handle or grip. This large size makes grasping easier for people with grasping issues. The inventive knife is designed for operation with four AA size batteries, and the interior of the oversized housing 20 must have a large enough diameter to accommodate the batteries arranged in parallel. The front 22 of the housing includes a substantially circular finger/hand guard 24. The rear end of the assembly 10 includes a removable cap 57 to the interior of the housing 20. In a preferred embodiment, the removable cap 57 attaches to the housing 20 by a pair of mating threads that permits the removable cap 57 to be screwed on and off of the housing to gain access to the interior of the housing 20. While some prior art culinary knives have hand guards, they are generally on the lower half of the housing or handle as this is where the blade is located. The finger/hand guard encircles the entire housing to prevent the user's hand from slipping off of the knife with the application of forward pressure or movement, a common occurrence for persons with weakened hand musculature. Also, the finger/hand guard 24 serves as an abutment surface for the user's hand to allow for the application of more forward pressure.

The blade 30, which is preferably serrated, is releasably attached within attachment slot 32, the release mechanism operated by a pushbutton 34 located on the side of the housing 20. The attachment slot 32 is situated in a forwardly extended portion 36 of the housing 10; the extended portion 36 positioning the blade 30 forward of the user's hand. An on/off switch 40 is positioned next to a push button 34 and serves to apply electrical power to the reciprocating mechanism. A key aspect of the invention is that the knife assembly 10 can be actuated without continually depressing an activating switch. This is accomplished by a pressure-sensing mechanism 42 situated inside of the compartment 44.

The pressure-sensing mechanism 42 is a micro-switch which is positioned to sense when pressure is applied to the blade as would be apparent to one of skill in the art. When pressure is applied to the blade at an outer end, the attachment end of the blade 30 pivots about its connection within the housing 20 causing the micro-switch within the pressure-sensing mechanism 42 to close. When the pressure is released from the end of the blade 30, the force on the micro-switch is removed, and the pressure-sensing mechanism 42 deactivates the motor 50.

When a user positions the blade 30 in contact with the food item to be cut, and the power is switched on via the switch 40, the mechanism 42 actuates the reciprocating motion. The reciprocating motion is generated by a motor 59 within the housing 20 that causes a shaft 65 and gears 66 to rotate. This rotation is connected to the attached end of the blade 30 causing it to move in a reciprocating motion.

When the blade 30 is removed from the food item actuation ceases as described above. The knife 10 will not operate unless there is pressure sensed by the micro-switch 42 and the on/off switch 40 is in the on position. This operation, in combination with the ergonomic handle portion 46, allows for nearly effortless use of the assembly. The ergonomic handle portion 46 is preferably covered with a compressible material 48 such as silicone rubber or equivalent; the material 48 may be textured to improve grip as is known in the art. While shown as cylindrical, the handle portion 46 may be tapered with the larger diameter portion toward the rear of the handle 46. This configuration would cause the user's hand to slide toward the hand guard 24, which allows the fingers to work together in contrast to prior art handles with finger indents. In lieu of the pressure-sensing mechanism, the hand guard 24 can include a switch so that forward pressure on the hand guard can be used to actuate the blade 30.

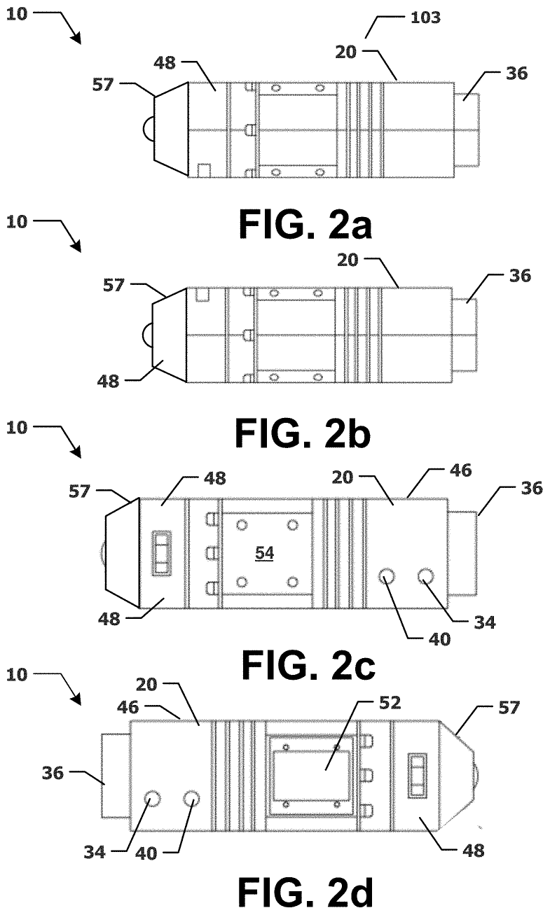

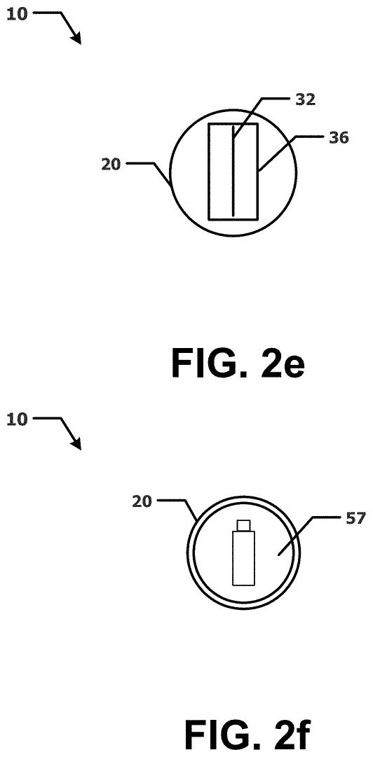

FIGS. 2a-f show various views of a first embodiment of a reciprocating knife assembly of the present invention. FIG. 2a shows a top view of the first embodiment of the reciprocating knife assembly 10 according to the present invention. FIG. 2b shows a bottom view of the first embodiment of the reciprocating knife assembly 10 according to the present invention. FIG. 2c shows a rear view of the first embodiment of the reciprocating knife assembly 10 according to the present invention. FIG. 2d shows a front view of the first embodiment of the reciprocating knife assembly 10 according to the present invention.

Similarly, FIG. 2e shows a front end view of the first embodiment of the reciprocating knife assembly 10 according to the present invention. FIG. 2f shows a back end view of the first embodiment of the reciprocating knife assembly 10 according to the present invention.

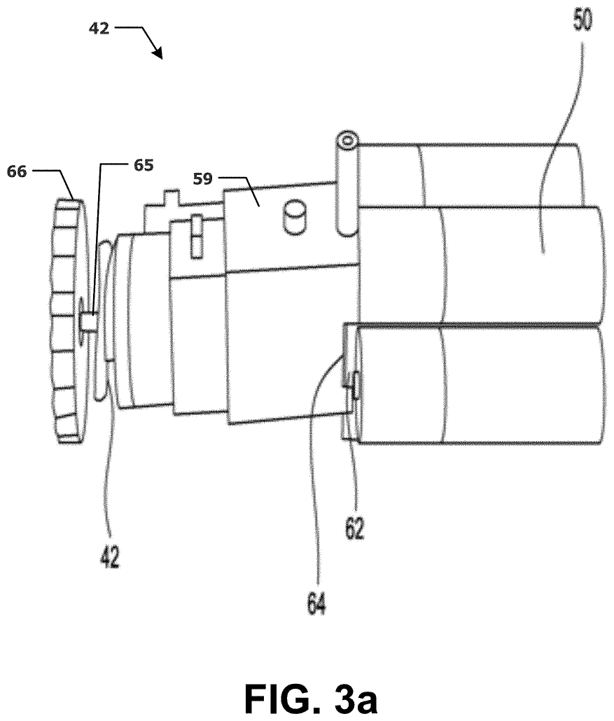

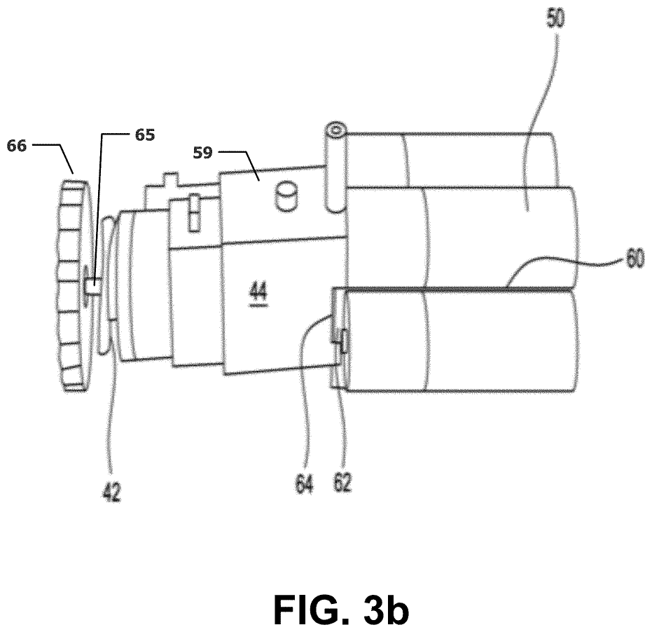

FIGS. 3a-b show perspective views of a first embodiment of the mechanism within a reciprocating knife assembly according to the present invention. Power for the assembly 10 is provided by way of a battery pack 50. A battery chamber 52 formed within the housing 20 is sized to receive the battery pack 50. In an alternative embodiment, the chamber 52 is enclosed by a removable panel 54 via interlocking tabs 56 and slots 58 in the well-known manner. In the example shown, the battery pack 50 comprises a receptacle 60 for containing the individual batteries, the batteries electrically connected to a contact portion 62 of the receptacle 60. The batteries 50 are arranged in parallel so that a minimum inner diameter of the housing 20 is established, and correspondingly the ergonomic, oversized outer diameter of the housing. The contact portion 62 is sized for sliding engagement within a slot 64 formed in the compartment 44 so as to provide electrical power to the reciprocating mechanism 42.

The reciprocating mechanism 42 comprises the electrical motor 59 that is powered by the battery pack 50. The electric motor 59, when in operation, rotates a shaft 65 that is coupled to a set of gears 66 which engage the blade 30 causing the blade to move in a reciprocating motion. The electric motor 59 is activated by the closing of both the on/off switch 40 and the micro-switch within the pressure-sensing mechanism 42. The pressure-sensing mechanism 42 is coupled to the end of the blade 30, when installed, and configured to close the micro-switch when pressure is applied onto the blade 30 when in contact with the food item being cut. The pressure that is applied to the blade 30 causes the blade to pivot about its attachment location in which the pivoting blade 30 closes the contacts of the micro-switch.

In operation, the user grasps the housing 20, with hand about the ergonomic portion 46 of the housing. The user then positions the blade 30 on the food item to be cut which initiates actuation of the reciprocating mechanism as discussed above. For users with grasping issues, the tendency is for the hand to slide forward and engage the guard 24. When finished, the user simply removes the blade 30 from the food item to shut off the mechanism.

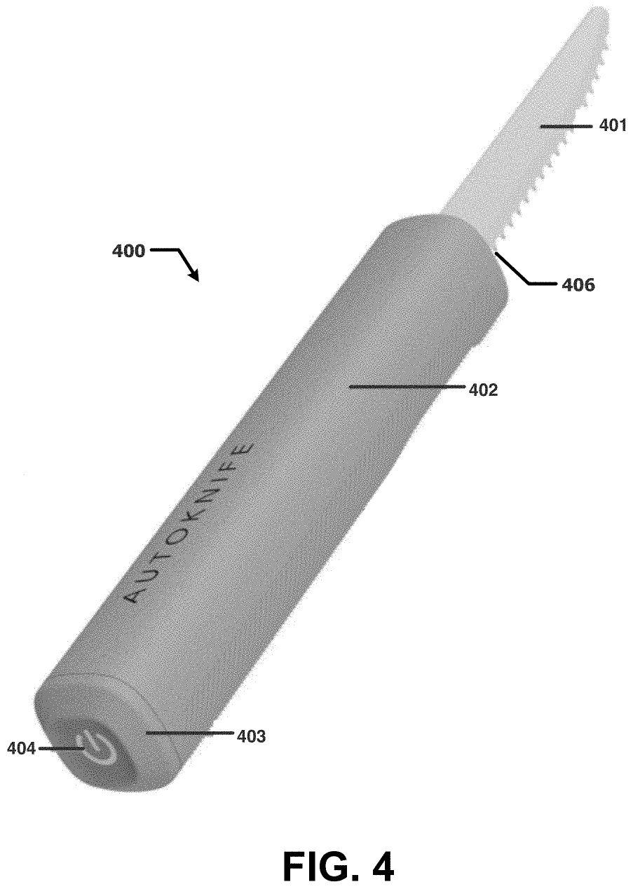

FIG. 4 shows a perspective view of a second embodiment of the reciprocating knife assembly according to the present invention. In the second embodiment, the carving knife 400 comprises a blade 401, a handle 402, a screw-on battery access cap 403, and an on/off power switch 404. The blade 401 is preferably serrated and may be inserted into a slot 406 in a front end of the handle 402 for coupling to the reciprocating motion mechanism 603-604 therein. The blade 401 is easily removable in order to permit the blade to be washed separate from the handle 402 after use.

The handle 402 contains an internal cavity as shown in FIG. 6 containing storage for a battery pack 602 that is coupled to the on/off switch 404 on one end and the reciprocating motion mechanism 603-604 on the other end. The handle 401 is covered in a silicone external skin having a soft material for ease of handling. The battery access cap 403 attaches to the handle 402 using mating threads to enclose the cavity within the handle 402. The battery access cap 403 has an O-ring about the threads to form a seal between the handle 402 and the battery access cap 403 in order to protect the contents of the cavity within the handle 402.

The on/off switch 404 is coupled to the outer side of the battery access cap 403 presenting a power icon containing a white translucent plastic light-pipe beneath a silicon skin. The on/off switch 404 is activated by depressing the switch for greater than one second. The on/off switch 404 is also deactivated in the same manner. The on/off switch is electrically coupled between the battery pack 602 and the reciprocating motion mechanism 603-604 to control the operation of the carving knife 400. An LED (not shown) may be included as a part of the on/off switch 404 to provide an indication of the operating state of the carving knife 400. The LED may present a solid neutral white color when in an on state and also may present an amber color when the battery pack 603 is low. The battery pack 603 may include either rechargeable or disposable batteries.

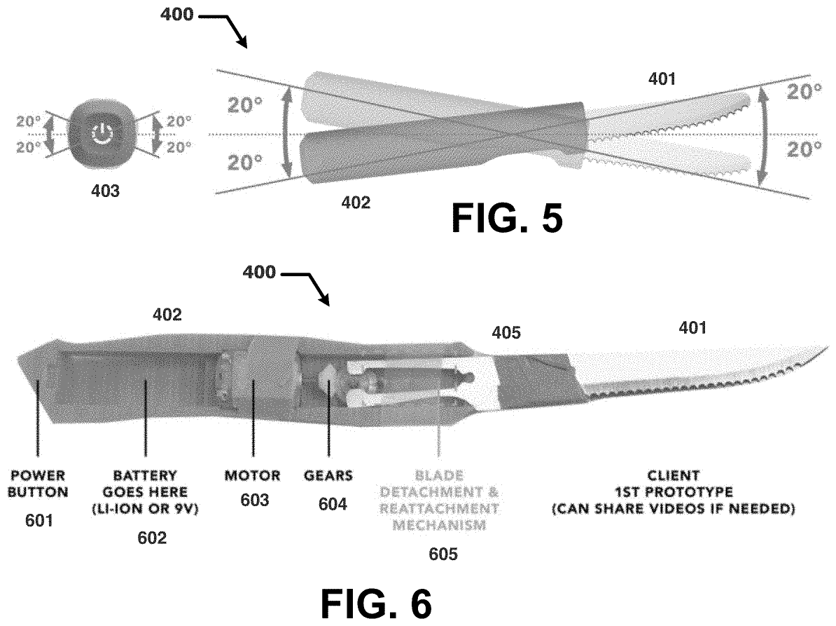

FIG. 5 shows a perspective view of a second embodiment of the reciprocating knife assembly according to the present invention. In this second embodiment, the reciprocating-motion mechanism 503 activates the motion of the blade 401 when the on/off switch 404 is activated and then when the knife 400 is positioned in a slightly angled forward cutting position. The reciprocating-motion mechanism 703 detects this orientation and activates a motor 603 to move the blade 401. The reciprocating-motion mechanism 703 stops the motor 713 when the knife 400 moves out of the slightly angled forward cutting position. In a preferred embodiment, the slightly angled forward cutting position is within +/−20° of horizontal for the blade 401 and handle 402.

FIG. 6 shows a perspective view of a second embodiment of the mechanism of the reciprocating knife assembly of the present invention. The reciprocating-motion mechanism 704 includes a motor 713, a set of gears 714 coupling an inner end of the blade 401 to the reciprocating-motion mechanism 703, and a blade-securing attachment mechanism 715. The reciprocating-motion mechanism 703 also contains electronics 721 to detect and activate the motor 713 when the on/off switch 711 is activated. The electronics 721 may include a position sensor (not shown), such as a tiltometer or an accelerometer integrated circuit, to determine the orientation and motion of the carving knife 400. Control logic within the electronics 711 translates output of the position sensor to control the operation of the motor 603. The control logic may be implemented using combinatorial logic, a state machine, and a programmable computing device executing instructions contained herein.

The motor 713 is coupled to a set of gears 714 permitting the rotation of a shaft 722 for the motor to translate the motion of the blade 401 into a reciprocating motion. The gears 714 couple to the blade 401 at the blade-securing attachment mechanism 715 in which the removable blade 401 is secured within the handle 402.

It is to be understood that the present invention is not limited to the sole embodiment described above, but encompasses any and all embodiments within the scope of the following claims:

1. A reciprocating culinary knife assembly comprising:
a cylindrical housing having a handle portion, the said housing being tapered with a larger diameter portion toward a rear of the handle;
a cutting blade connected within and extending forwardly from said housing;
a reciprocating assembly within said housing for causing reciprocating motion of said blade;
a pressure sensing mechanism within said reciprocating assembly for sensing contact of said blade with a food item;
a hand guard positioned at a forward end of said housing;
whereby, using said hand guard as an abutment member, a user may initiate operation of said reciprocating assembly by contacting and applying pressure to said food item.

2. The knife according to claim 1, wherein operation of said reciprocating assembly is ceased upon cessation of pressure to said food item.

3. The knife according to claim 1, wherein said housing has a larger diameter rear portion.

4. The knife according to claim 1, wherein said housing is covered in a compressible material.

5. The knife according to claim 1, wherein said housing has an inner diameter sized to accommodate 4 AA sized batteries connected in parallel.

6. The knife according to claim 1, wherein the hand guard is circular about the abutment member.

7. A reciprocating culinary knife assembly comprising:
a removable cutting blade;
a handle having an internal cavity containing a reciprocating-motion mechanism coupled to the removable cutting blade;
a battery pack for powering the reciprocating-motion mechanism; and
an on/off switch electrically coupled between the battery pack and the reciprocating-motion mechanism.

8. The reciprocating culinary knife according to claim 7, wherein the reciprocating motion mechanism comprises:
a blade-securing attachment mechanism removably coupled to the removable cutting blade;
a motor coupled to the on/off switch and the battery pack, the motor having a rotating shaft;
a set of gears coupled to the rotating shaft to translate the rotation of the shaft into reciprocating motion of the removable cutting blade about the blade-securing attachment mechanism; and
control electronics for controlling the operation of the motor.

9. The reciprocating culinary knife according to claim 8, wherein the control electronics comprise:
a position sensor, the position sensor comprises a tiltometer and an accelerometer; and
a control logic for translating output of the position sensor to control the operation of the motor.

10. The reciprocating culinary knife according to claim 9, wherein the control logic comprises combinatorial logic, a state machine, and a programmable computing device and memory for executing instructions contained.
